(19) United States
(12) Patent Application Publication
(10) Pub. No.: US 2007/0192373 A1
(43) Pub. Date: Aug. 16, 2007

(54) Recovery of logless components

(75) Inventor: David B. Lomet, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/354,374

(22) Filed: Feb. 15, 2006

(51) Int. Cl. G06F 17/30

(52) U.S. Cl. 707/200

(57) ABSTRACT

Recovery processing of logless components is disclosed. Logless components in middle-tier systems can be checkpointed to provide faster recovery. In particular, a client system, executing a persistent component and itself logging, initiates a snapshot method that returns to the client the values of all variables and other state of the logless component during normal execution. The client writes this data to the client log along with information about the initiation call. To recover the logless component, the client invokes a restore method which takes as an argument values returned from the snapshot method and included in the checkpointing portion of the client log relating to the logless component. This information is sufficient for recreating the logless component which is logically identical to the failed logless component and for setting its state to the checkpoint state. This can occur transparently and shorten the recovery time in providing exactly-once execution.

### BACKGROUND

Enterprise applications must be highly available and scalable. This has classically required “stateless” applications that manage their states explicitly via transactional resource managers. “Stateful” applications, on the other hand, are more natural, easier to write, and hence, get correct. The execution state captures much of the application state without having to manifest it. This part of the state manages itself, and as a result, the programmer can better focus on the business logic. However, having the system manage state automatically has heretofore been considered too difficult and costly.

Robust applications enable enterprise systems to support highly available and scalable service. Such applications must survive system crashes and be re-deployable on other computers as the system changes and grows. Despite this dynamic activity, “exactly once” execution semantics should be provided. In other words, an application can start execution on one computer, that computer system crash, and then be redeployed on another computer, etc., and to the application client, it looks like a seamless execution in which the application executed exactly once without crashing or moving.

Letting business logic dictate how developers program their application is easy and natural. The resulting application is usually “stateful”. In the past, this has compromised availability and scalability. A stateful application has control state across transaction boundaries, incurring the risk of losing state should the system on which it executes crash. This creates a “semantic mess” that can require human intervention to repair the state and it results in long service outages.

Classic transaction processing insists that applications be stateless, which means “no meaningful control state” is retained across transactions. This stateless model forces an unnatural “string of beads” programming style where a program is rearranged to fit the model. In other words, the programmer manages the state by organizing the program to facilitate state management. The state information is stored in a database and/or transactional queue. An application must, within a transaction, first read its state from, for example, the transactional queue, then execute its logic, and finally, commit the step by writing its state back to a transactional queue for the next step. “State” is not avoided; rather, it is managed in a transactional way. Potential performance and scalability problems related to the message and log cost of two-phase commit may also be encountered which can affect performance and latency.

An application programmer thus faces a dilemma of having to choose between fast, easy development, resulting in applications that are more likely to be correct, implemented in a natural stateful programming style, but which fail to provide availability and scalability, and high availability and scalability via the stateless programming model, which adds to development time and makes correctness harder to achieve because of the need for explicit state management.

In one prior software technique, the system manages application state transparently by logging interactions between components, thereby guaranteeing exactly-once application execution. However, for middle tier session-oriented components, it is possible to avoid logging interactions in order for them to survive system crashes. Because there is no logging, performance of failure-free execution is excellent. Availability and scalability are possible with this prior technique, but require maintaining the log, forcing the log, and shipping of the log for recovery purposes. With performance, scalability, and availability being ever-present system aspects that demand improvement, the ability to avoid the need for logging in order to achieve scalability and availability of software components is desired.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

Disclosed herein are one or more techniques whereby logless components can be checkpointed to provide faster recovery. In particular, the instant innovation describes how a client, realized as a persistent component, and hence, itself logging, can provide the checkpointing function that permits a logless middle-tier component to recover more rapidly, thereby providing higher availability because the duration of system outages is reduced. A result is a session-oriented component that can survive system crashes and be easily redeployed within an enterprise application system that requires high availability and scalability. Additionally, the functions of maintaining the log, forcing the log and shipping of the log for recovery purposes are no longer required.

Accordingly, the invention disclosed and claimed herein, in one aspect thereof, comprises a computer-implemented system that facilitates exactly-once application execution. The system can include a logless component (e.g., a middle-tier component) for processing a sequence of events, and a client component for controlling a recovery process of the logless component. The client component can be a Pcom (persistent component realized by logging) that includes a log that contains, among its log records, a history of its interactions with the logless component. A checkpointing function permits this client, which can provide recovery for the logless component, to recover this component more rapidly.

Logless components in middle-tier systems can be checkpointed to provide faster recovery. In particular, a client, realized as a persistent component and itself logging, performs a checkpoint by initiating a checkpoint method of the logless component that returns to the client the values of all variables of the logless component plus other system related information. The client writes this data to the client log along with information about the initiation call. During logless component recovery, the client invokes a restore method, which takes as an argument values returned by the checkpoint method that were recorded on the portion of the client log relating to the logless component. This information is sufficient for recreating the logless component, which is logically identical to the failed logless component, and for setting its state to the checkpoint state.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates exactly-once application execution in accordance with an innovative aspect.

FIG. 2 illustrates a methodology of recovery processing of a logless component according to a novel aspect.

FIG. 3 illustrates a computer-implemented system that employs checkpointing for recovery of the logless component in accordance with an aspect.

FIG. 4 illustrates a flow diagram that represents a methodology of recovery checkpointing in accordance with a novel aspect.

FIG. 5 illustrates a methodology of truncating the recovery log via functionality downloaded from the middle-tier in accordance with an aspect.

FIG. 6 illustrates a flow diagram that represents a methodology of facilitating recovery from a middle-tier component in accordance with a novel aspect.

FIG. 7 illustrates a methodology of initiating recovery from the client.

FIG. 8 illustrates a block diagram of a computer operable to execute the disclosed checkpointing architecture.

FIG. 9 illustrates an exemplary system that employs logless component checkpointing in accordance with the instant innovation.

FIG. 10 illustrates a schematic block diagram of an exemplary two-tier client/server computing environment that can employ logless component checkpointing in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Beginning with a brief introduction, systems can contain a notion of middle-tier components, logless middle-tier components (LLcom's), persistent components (Pcom's), and client components, where one or more of the components can be stateful. Components declared as Pcom's survive system crashes. Components declared as transactional (Tcom's) should have a testable transaction state, as in transaction processing and e-transactions. Other component types can have other requirements. Pcom's can serve multiple calls from multiple clients, send messages to other Pcom's or Tcom's, etc., while providing exactly-once semantics.

In order for a system to ensure that Pcom's persist across system crashes, the interactions of each Pcom are logged so that the Pcom can be deterministically replayed, using the log to capture nondeterministic events (the interactions) and their potentially nondeterministic arrival order. A Pcom log also permits it to be recovered independently of other components. The logging is what permits it to satisfy the requirements of what are called “interaction contracts”. These contracts require components to guarantee that their state and messages will survive system crashes and provide exactly-once executions. It is this logging that permits a Pcom to engage in relatively unconstrained activity with other Pcom's and Tcom's while maintaining persistence across crashes.

An LLcom is a session-oriented component type that avoids logging while being persistent and stateful. The LLcom exploits the logging done already by other components. The LLcom can be called multiple times and interact with a number of backend systems involving a number of transactions, while retaining its persistent state. LLcom's can be easily redeployed across an enterprise system, since no log needs to be shipped. In addition to their availability and scalability advantages, LLcom's perform better during normal execution because no logging is required; indeed, no interception of messages is required.

To provide persistence without logging, LLcom's need to be restricted in what they can do. According to one restriction, all interactions initiated in the middle tier should be idempotent. That is, an interaction can be replayed multiple times while only producing a state change exactly once, and always returning the same result. Further, due to the absence of a middle-tier log, an LLcom cannot itself shorten its recovery time by taking a checkpoint.

LLcom's can be made more capable by introducing the capability of the LLcom to read system state without the need for these reads to be idempotent. Additionally, checkpointing can be employed to shorten recovery time of a failed LLcom. With respect to reading system state, the notion of idempotence that is provided at backend services can be generalized. This enables read results to vary without changing the backend state, while guiding the middle tier state back to a replayable trajectory. These read results cannot affect the choice of which backend service to visit. In addition, “wrap-up” reads are described that do not impact middle-tier state in the current method call, but can return results to the client that impact subsequent execution of both client and middle tier. In particular, a wrap-up read can impact the choice of backend service visited in the next LLcom method invocation. In each case, the read is followed by logging that captures the logical impact of the first successful read execution. Even if the read, when repeated produces different results, the first read will govern subsequent execution.

The shortened recovery time via checkpointing permits more flexible deployment and higher availability. Since there is no log directly associated with LLcom's, the definition of checkpoint is extended to enable client Pcom's to perform the checkpoint process for the LLcom. The LLcom costs associated with maintaining the log, forcing the log, and shipping the log so as to redeploy the LLcom are all eliminated for the middle-tier component. It is the log at the client Pcom that interacts with the LLcom that has the opportunity to shorten recovery for the LLcom in the process of shortening its own recovery. However, it needs to exploit additional LLcom functionality to make this possible.

An LLcom has no log. Hence, it is meaningless to talk about checkpointing for its log so as to shorten its recovery time. Whenever an LLcom crashes or is deallocated to free up resources to enable scalability or other system management goals, it can be recreated via complete replay of its entire execution history, starting from its initiation message. It is desirable to perform this replay quickly to achieve high availability and minimize system overhead. This argues for keeping the lifetime of LLcom's short.

An LLcom relies upon other components for logging its interactions. Thus, without checkpointing, the replay time is governed by LLcom execution time, and the time required for other components to respond to its replayed interactions. The time involved for LLcom execution will usually be much shorter than the original execution time, since other components will usually not need to re-execute requests during replay. Rather, they will normally simply look up the messages sent to them by the LLcom and generate replies based on information that they have retained in a table. Accordingly, lifetime has been a function of LLcom execution path plus the number of interactions times the replay time for each interaction, not the original time required to execute code to reproduce the result of the original interaction.

Keeping LLcom lifetime short is a pragmatic consideration. Long-lived LLcom's will work correctly, subject to the other considerations addressed herein. It is the practical value of the LLcom that diminishes as its lifetime increases.

A system that implements LLcom's may want to be able to determine lifetime in some syntactic way prior to deploying the components in a live system. An easy way to do this is to preclude loops and perhaps to impose a limit on the number of calls that an LLcom can make or can receive. This permits knowing the execution path of the LLcom and the number of interactions in its lifetime. Less restrictive conditions could also be satisfactory.

When at the end of its lifetime, the LLcom goes “stateless”. At that point, there is no state that needs to persist. For example, if an LLcom's lifetime is bracketed by a method call/return, then once its caller logs the return message, there is no longer any state that needs to be recovered. At that point, replay of the LLcom is no longer necessary and the LLcom can be deallocated.

The instant innovation focuses on checkpoint processing of the client log for fast recovery of a failed LLcom, thereby facilitating higher availability via shorter time to recover (repair).

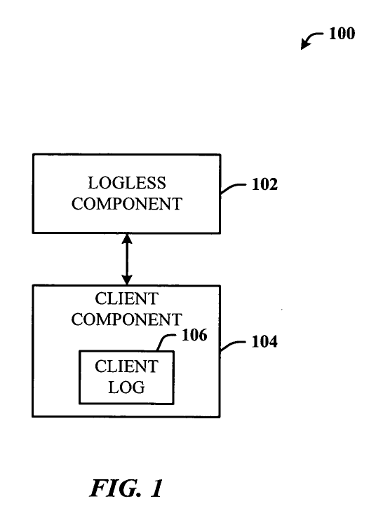

Referring initially to the drawings, FIG. 1 illustrates a computer-implemented system 100 that facilitates exactly-once application execution in accordance with an innovative aspect. The system 100 can include a logless component 102 (e.g., a middle-tier component), and a client component 104 that controls a recovery process for the logless component 102 via logging its interactions with the logless component 102 and checkpointing of its state in order to shorten recovery time when the logless component 102 fails. The client component 104 can be a Pcom that includes a client log 106. The checkpointing function permits the logless component 102 to recover more rapidly.

Checkpointing normally involves moving a redo scan start point on the log associated with the recoverable object. Even though an LLcom has no log in the middle tier, as described herein, an LLcom can assist in checkpointing so as to shorten its recovery after a failure.

A way to understand the novel checkpointing technique for LLcom recovery is to think of the client Pcom 104 as providing the LLcom recovery log 106. By reducing the part of the log 106 that needs to be scanned by the client Pcom 104 in order to recover the LLcom 102, the LLcom 102 can be more efficiently recovered.

To accomplish this, the LLcom 102 state should be captured during a time when its “ordinary” methods are inactive, since at that time, control state can be inexpensively captured, i.e., there is no control state. Unlike Pcom checkpointing, which can be done under the control of local Pcom infrastructure, LLcom checkpointing involves the client Pcom 104.

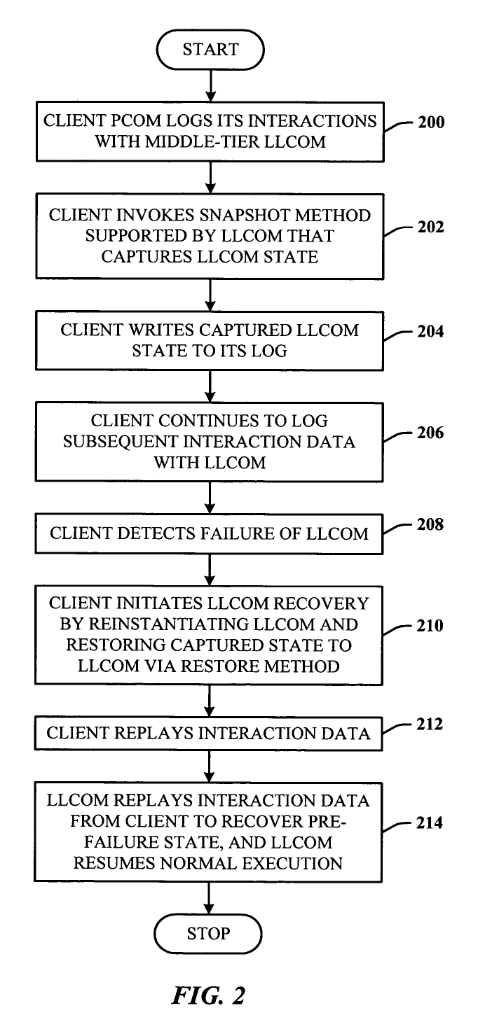

FIG. 2 illustrates a methodology of recovery processing of a logless component according to a novel aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, the client Pcom logs its interactions with the middle-tier LLcom. At 202, the client invokes a snapshot method supported by the LLcom that captures the state of the LLcom. At 204, the client Pcom writes the state returned by the snapshot method to its log. At 206, the client Pcom continues to log its subsequent interactions with the LLcom. At 208 the client component detects the failure of the LLcom. At 210, the client provides recovery for the LLcom by reinstantiating it and then restoring the state captured at 204 to the LLcom via a restore method invocation. At 212, the client component replays its interactions with the LLcom that it captured at 206, ignoring the interactions it had with the LLcom that were captured at 200. At 214, the LLcom replays the interactions from the client so as to recover its pre-failure state, after which it resumes normal execution.

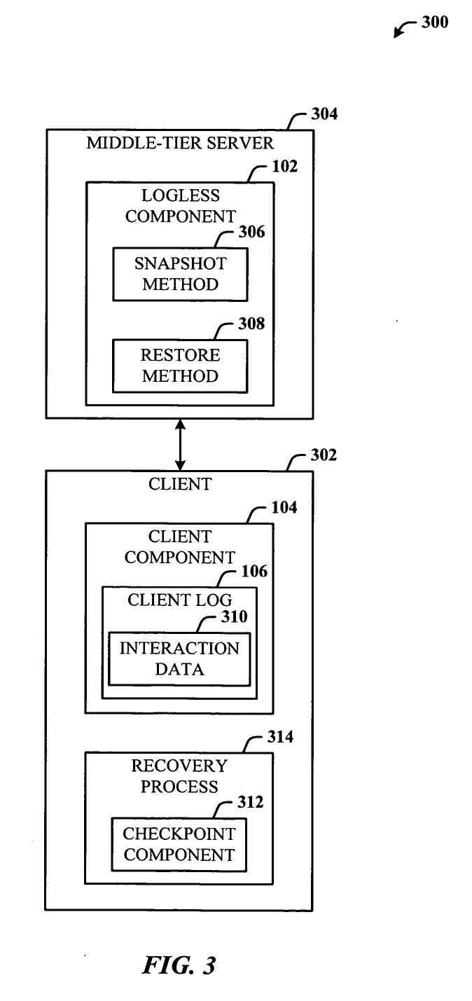

FIG. 3 illustrates a computer-implemented system 300 that employs checkpointing for recovery of the logless component 102 in accordance with an aspect. What is desired for the client component 104 of a client 302 is a mechanism whereby the client log 106 is shortened and the number of LLcom invocations reduced in order to more quickly recover the LLcom 102.

In this implementation, LLcom 102 in, for example, a middle-tier server 304 can support at least two methods: a snapshot method 306 and a restore method 308. The snapshot method 306 is an “extraordinary” method in that its control state is unimportant, since it is providing a system function, not an application function. The snapshot method 306 should capture both state visible to the application and the LLCOM system state needed for fault tolerance. It is desired that all LLcom's support these methods (306 and 308), and that the application programmer is not burdened with implementing them. Additionally, it may be desired to include LLcom's in a class hierarchy where the snapshot and restore methods (306 and 308) can be inherited by all LLcom's.

As before, the client Pcom 104 is associated with the client log 106 for recording its interactions (via interaction and call data 310) with end users and with middle-tier components, including the LLcom 102. As shown here, the snapshot method 306 facilitates checkpoint processing for a portion of the client log 106 related to events recorded from the LLcom 102 by a checkpoint component 312 that can be part of a recovery process 314 of the client 302. Note that the snapshot method 306 is a method of the LLcom 102, and the checkpoint process is internal to the infrastructure present at the client 302.

Recovery process checkpointing for an LLcom includes capturing of state of the variables of the LLcom 102 stably so that operations on the client log 106 that precede the LLcom state so captured do not need to be replayed. The redo log scan start point can be moved to later in the client log 106 when all earlier operations on the client log 106 no longer need to be replayed because recoverable object states have been captured stably in some way.

For LLcom checkpointing, the client component 104 invokes the snapshot method 306 of the LLcom 102. The snapshot method 306 returns to the client component 104 the values of all variables and associated system state of the LLcom 102. The client component 104 then writes this interaction information to the client log 106, along with information about the initiation call. This collection of information 310 is sufficient for recreating the LLcom 102 and for setting its state to the checkpointed state.

The second method that all LLcom's should support is the restore method 308. During recovery, the client Pcom 104 invokes the LLcom restore method 308 which takes as an argument what had been returned by the snapshot method 306 (e.g., the set of variables and their values, associated system state, etc.). The restore method 308 then sets the variables of the LLcom 102 to the values captured by the snapshot method 306, restores system variables, etc.

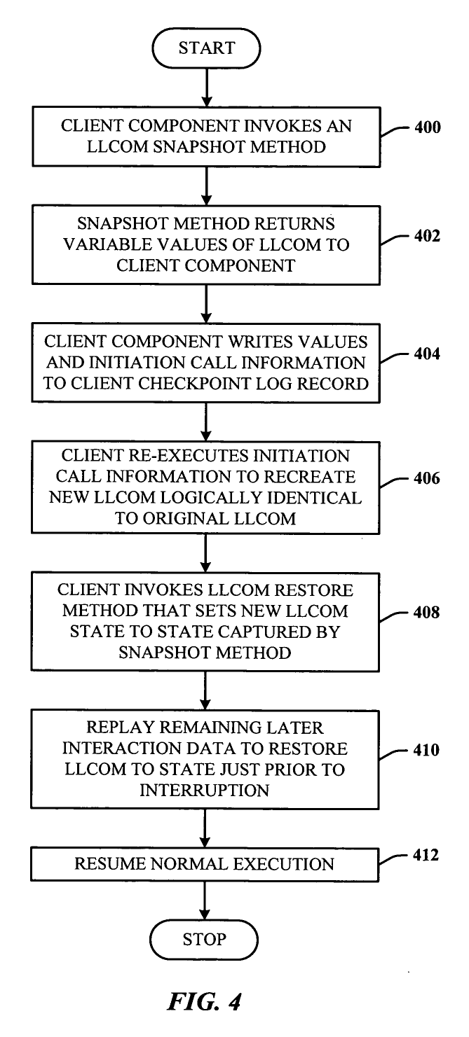

Accordingly, FIG. 4 illustrates a flow diagram that represents a methodology of recovery checkpointing in accordance with a novel aspect. At 400, the client component invokes the LLcom snapshot method. At 402, the snapshot method returns to the client component the values of all variables of the logless component, both application and system variables. At 404, the client component then writes this information to its client log, along with information about the initiation call in a checkpoint log record. At 406, to recreate the LLcom without replaying earlier interactions for the LLcom that precede the checkpoint, the client Pcom 104 re-executes the initiation call to recreate a new LLcom that is logically identical to the original LLcom. At 408, the client then invokes the LLcom restore method that sets the LLcom state to the state captured by the snapshot method. At 410, the remaining interactions (later on the log) that the client Pcom had with the LLcom are replayed to restore the LLcom to its state immediately prior to its interruption. Then normal execution resumes, as indicated at 412.

This enables the client to act as a recovery manager, checkpointing the LLcom state, and restoring it to shorten recovery. This might seem to place a burden on the client Pcom that previously was borne by the recovery infrastructure of the middle tier. Note, however, that aside from checkpointing for the LLcom, the logging at the Pcom is required to recover the Pcom itself. It is the client log that has captured the method calls that the client Pcom has made to the LLcom, and their order, which would represent nondeterminism at the LLcom. Thus, the client has the information needed to re-create the failed LLcom. Accordingly, a responsibility of the client to manage recovery cannot be easily avoided. It is desired that the infrastructure handle this, however, and not the client Pcom application.

One common client is a web browser. Web browsers do not ordinarily directly provide the Pcom functionality or the recovery infrastructure needed by the client to provide recovery for both client Pcom and a middle tier LLcom. However, it is possible to download this functionality from the middle tier. One of several different ways to automatically provide the necessary infrastructure can be as described in EOS (exactly-once e-service) middleware. EOS supports browser-based clients that work together with middle-tier components to provide exactly-once execution semantics. EOS ensures that client and middle-tier component applications satisfy conventional multi-tier recovery guarantees.

The EOS infrastructure is provided from the middle tier, and directly meets the middle-tier component requirements by intercepting messages to and from the middle tier and performing the appropriate logging. The EOS also provides the client functionality for recovery guarantee requirements.

In operation, when a user of a web browser accesses the initial EOS-enabled (middle tier) website, the middle-tier infrastructure, transparent to the middle-tier business application, adds functionality to the dynamic HTML (DHTML) page downloaded to the client. This DHTML page can include scripts for capturing user input and client interactions with the middle tier in the browser-supported stable storage that serves as the client log.

In one implementation, the checkpoint functionality described herein is transparently downloaded as a script to the browser client. This script monitors the number of LLcom calls that have been made and can use this as a proxy for recovery time. Once the number of calls has reached a checkpoint threshold, the downloaded script invokes the LLcom snapshot method, storing the snapshot information in the client log as part of the checkpoint log record.

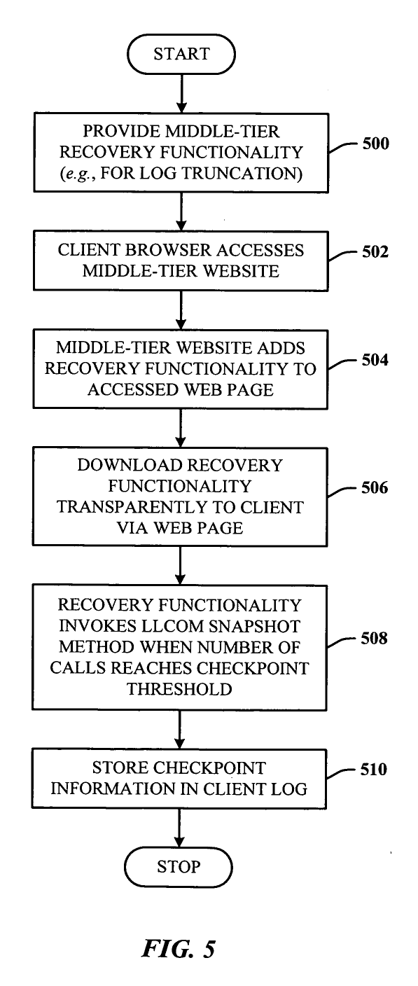

FIG. 5 illustrates a methodology of truncating the recovery log via functionality downloaded from the middle-tier in accordance with an aspect. At 500, recovery functionality, including log truncation functionality, is provided from a middle-tier website, for example. At 502, the client browser accesses the middle-tier website. At 504, the middle-tier website adds recovery functionality (e.g., via a script) to the accessed web page. At 506, the recovery functionality is downloaded transparently to the client via the downloaded web page. At 508, a checkpoint is taken using part of the recovery functionality. This involves invoking the LLcom snapshot method when the number of calls reaches a predetermined checkpoint threshold. At 510, the checkpoint information is then stored in the client log.

In one implementation, the recovery process can be initiated by the middle-tier. For example, EOS initiates recovery when a client re-connects to the middle tier. The middle tier, on any connection (or re-connection) sends a DHTML page that is “decorated” with script providing the recovery manager functionality described herein. When the script first arrives at a client, it checks the client log (e.g., an XML store) to determine if there is an interrupted session logged at the client for the given website. If it finds such a situation, then the script initiates recovery, both for the client Pcom and the middle tier LLcom, reading the client log, re-issuing the functional create for the LLcom involved, invoking the restore method with the last checkpoint found on the log, and replaying the LLcom invocations following the last checkpoint. This activity re-creates the LLcom in the middle tier. When recovery is complete, the client Pcom infrastructure resumes execution of the application-provided Pcom code to continue with the business application.

The client Pcom, when it finds a checkpoint on its log, can initiate recovery for the middle-tier LLcom by invoking the restore method and replaying only method calls that follow the checkpoint. Further, the middle tier infrastructure can assist in making replay more efficient if it is willing to accept the entire set of messages in the replay as a single batch. Once that message is received at the middle tier, it can provide recovery without further communication with client Pcom. Thus, only when recovery completes and normal processing resumes need the client again become active.

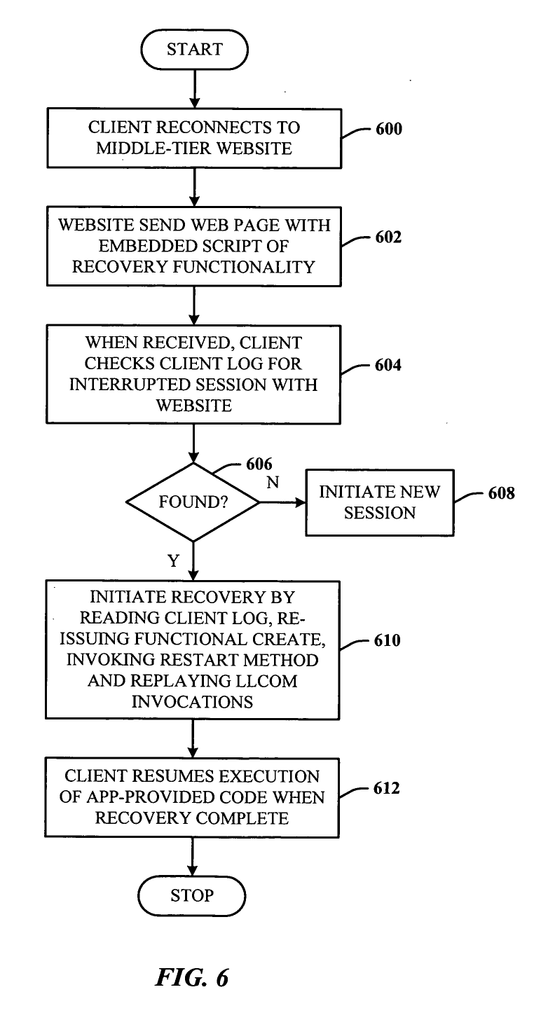

Accordingly, FIG. 6 illustrates a flow diagram that represents a methodology of facilitating recovery from a middle-tier component in accordance with a novel aspect. At 600, the client re-connects to the middle-tier component. At 602, the middle-tier component sends a DHTML page with embedded script that provides the recovery functionality to the client Pcom. At 604, upon arrival at the client, the script checks the client log for an interrupted session between the website and the client. At 606, if not found, then it is assumed that this is a new “session” and that session is initiated, at 608. If found, at 606, flow progresses to 610 where recovery is initiated by reading the client log (e.g., an XML store), re-issuing a functional create for the LLcom, invoking a restore method with last checkpoint found, and replaying the LLcom invocations following the last checkpoint. At 612, when the recovery process is complete, the client infrastructure resumes execution of application-provided code to continue with the business application.

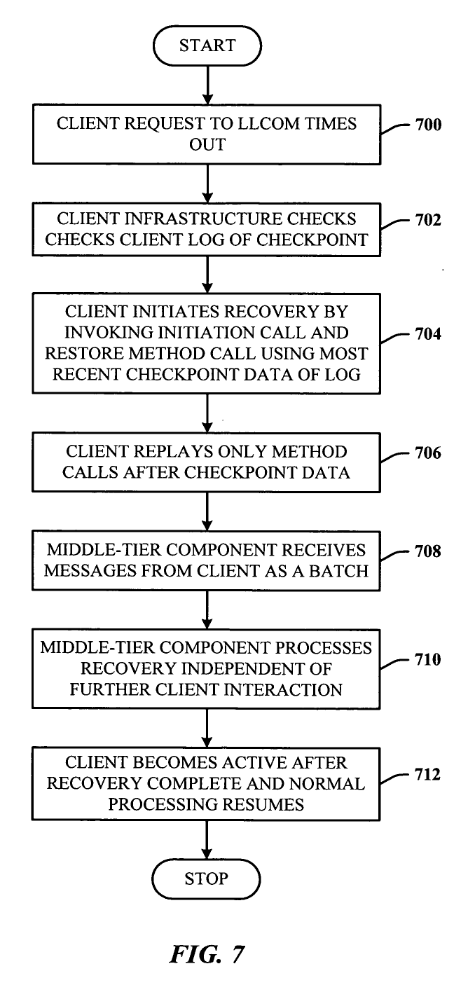

FIG. 7 illustrates a methodology of initiating recovery from the client. At 700, the client times out a request to a middle tier LLcom. At 702, the client infrastructure checks the client log for a checkpoint. At 704, the client initiates recovery for a middle-tier LLcom by invoking its initiation call, followed by a restore method call using the most recent checkpoint information on the client log. At 706, the client replays only method calls that follow the checkpoint. At 708, the middle-tier component accepts a set of messages as a batch, rather than individually. At 710, middle-tier component provides recovery without further communications with client. At 712, client becomes active after recovery is complete and normal processing resumes.

Following is a description of aspects related to making replay possible in view of call determinism, permitting non-idempotent reads, looking at wrap-up activity, and some examples.

A set of constraints for Pcom's can be provided to avoid logging. LLcom's do not require usually additional logging or log forces from the components with which they interact. For these components, the LLcom can be treated as if it were a Pcom, though these components can be required to keep messages stable for a longer period. The LLcom may also optionally choose to force their logs somewhat more often to provide for faster recovery.

To provide application replay, the nondeterminism that, during replay, would produce a different execution path, should be removed. Nondeterminism can be eliminated through a combination of restrictions on capability and exploitation of logging that is being done elsewhere. One source of nondeterminism is how components are named and mapped to the underlying physical resources. That nondeterminism needs to be removed without requiring that information be logged.

The LLcom should have what is called a “functional” initiation or creation. In other words, the entire information about the identity of the LLcom should be derivable from what is in its creation message. This aspect permits a resend of this creation message to recreate a new LLcom that is logically indistinguishable from any earlier incarnation.

The initiating (or initiator) component (the component making the initiating call) can, in fact, create an LLcom multiple times such that all instances are logically identical. Indeed, the initiator component might, during replay, create the LLcom in a different part of the system, such as in a different application server, for example. The interactions of the LLcom, regardless of where it is instantiated, are all treated in exactly the same way. During replay, any Tcom or Pcom whose interaction was part of the execution history of the LLcom will respond to the re-instantiated LLcom in exactly the same way, regardless of where the LLcom executes.

The initiator component should also initiate recovery for the LLcom. Unlike Pcom's, where the infrastructure hosting the Pcom supports a log and a recovery manager that handles recovery for local components, with LLcom's there is no log. So even were the infrastructure to have a recovery manager, it could not recover the LLcom. To provide LLcom recovery, the initiation call has to be replayed. Because the initiator Pcom must replay the initiation call for LLcom recovery to happen, it must also be able to detect an LLcom's failure.

Detecting failure may require that the initiator expect a message from its initiated LLcom and fail to receive it after some timeout period. While this expected message can be a “ping” it is clearly more useful if it is a reply to a Pcom request. Because of these constraints, LLcom system interactions and configurations are more restricted than for Pcom's. The initiator needs execution control to return to it in some way from every LLcom that it initiates. It can send multiple messages to an LLcom that it initiates, but it must always reach a state in which a message is expected from the LLcom. It is the failure of such a message to arrive that triggers the initiator to begin recovery via replay of the initiating message.

A component can initiate more than one LLcom, and an LLcom can initiate other LLcom's. However, the initial LLcom in the system should be initiated by a Pcom. These requirements ensure that LLcom's are recoverable. The Pcom initiating the first LLcom is independently recoverable via logging. Other LLcom's are recoverable either directly by the Pcom or by an LLcom that is recoverable by the Pcom. The originating Pcom makes this “recursion” well founded. Thus a Pcom can initiate a “tree of LLcom's” and successfully recover them.

LLcom's should be terminated as well. One way to do this is to impose responsibility on the initiating component. It should await a message from the LLcom whenever the LLcom is active, so that it can provide recovery. This also means that it can terminate the LLcom via a final message. However, this may not be essential. LLcom's that are inactive for a sufficiently long time might simply be deallocated, as they can be re-instantiated via replay if they are needed again.

Logging may not need to be forced when a Pcom interacts with an LLcom that it initiates. The initiating call might be an example of the multi-call optimization. Further, there may be no need to force log subsequent interactions. (Only user input and the result of a wrap-up read (because the read is not idempotent), which introduce non-determinism need to be logged with the log record forced to disk.) What is on the stable log is otherwise useful solely to optimize Pcom recovery. In all cases, the LLcom is guaranteed to be restartable from its initiating call, and subsequent replay of interactions with it may be entirely deterministic. Thus, Pcom replay, as long as it includes replay of an LLcom's initiating call, might not need to even log LLcom interactions, except to optimize its own replay.

Should the LLcom be alive during Pcom replay and only have retained information about its last call from the Pcom, it needs to self-destruct so that its complete replay is possible. When the LLcom no longer exists at a middle-tier site, the site can respond to the initiating Pcom that the message failed to be delivered because the target does not exist. At this point, the initiating Pcom can recover the LLcom by replaying messages to it starting at its initiating call.

The result of a first (non-idempotent) read can be captured on the log. Thereafter, during replay, it is the result on the log that is used to faithfully restore the middle-tier LLcom “persistent” state that was the result of the initial execution, even if the LLcom, in executing non-idempotent reads, actually follows a slightly different execution path.

The recovery process, including checkpoint functionality, is unchanged, even when these constrained non-idempotent reads are permitted.

In a brief and general summary, disclosed herein is a description of how to provide persistent session-oriented components in the middle tier that can read and respond to system state without requiring that such reads be idempotent. This can be done without requiring logging in the middle tier. This is full persistence, in which system crashes can occur at arbitrary times, including when execution is active within the component or when the component is awaiting a reply from a request. Coupled with idempotent backend services, a system using logless components can provide exactly-once execution semantics. Because no log is required, this component can be deployed and redeployed trivially to provide high availability and scalability.

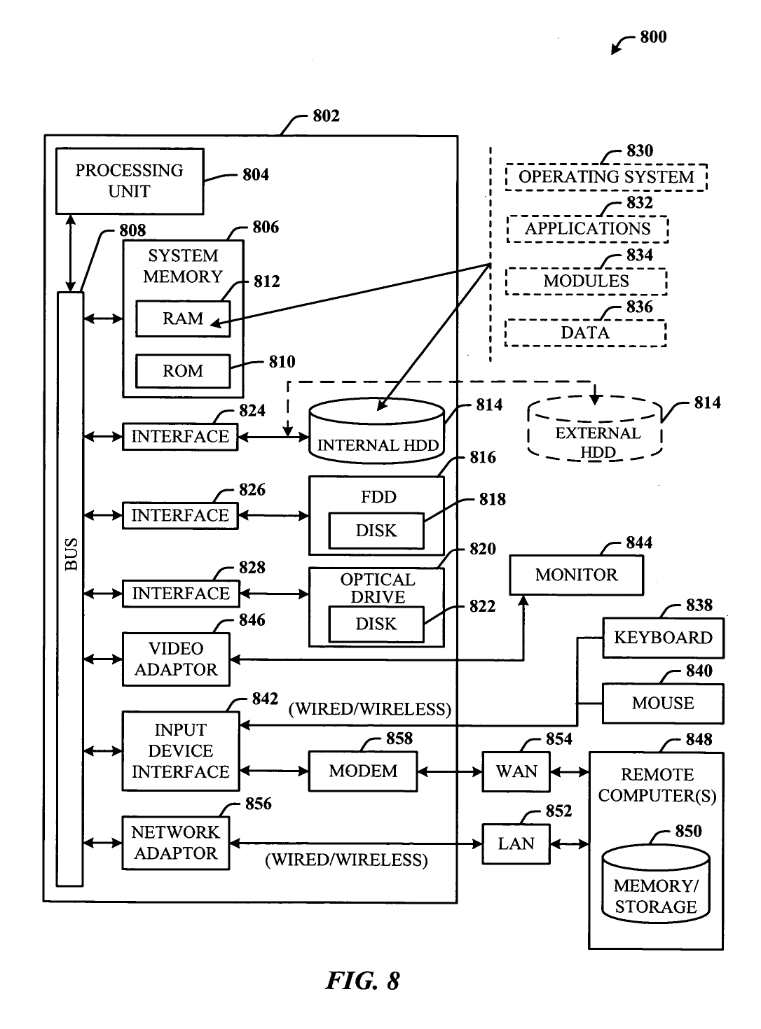

Referring now to FIG. 8, there is illustrated a block diagram of a computer operable to execute the disclosed checkpointing architecture. In order to provide additional context for various aspects thereof, FIG. 8 and the following discussion are intended to provide a brief, general description of a suitable computing environment 800 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the innovation can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11×(a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

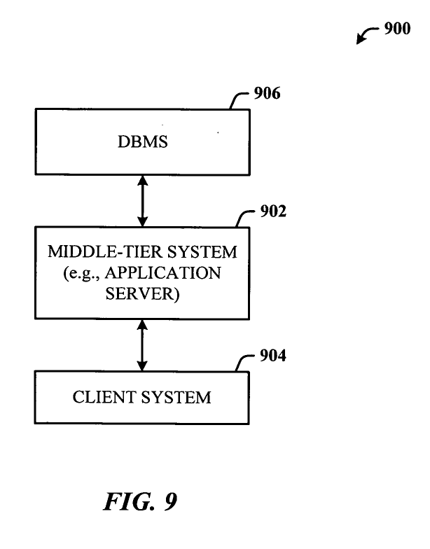

FIG. 9 illustrates an exemplary system 900 that employs logless component checkpointing in accordance with the instant innovation. Here, a middle-tier system 902 serves as an application server between a client system 904 and a database management system (DBMS) 906. The middle-tier system 902 performs the business logic. The client system 904 performs checkpointing of the client log (not shown) for recreation of a failed LLcom (not shown) in the middle-tier system 902.

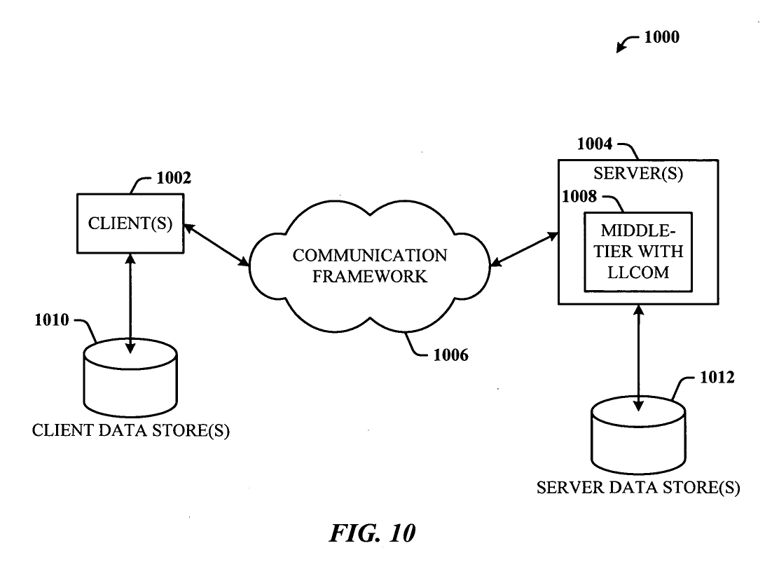

Referring now to FIG. 10, there is illustrated a schematic block diagram of an exemplary two-tier client/server computing environment 1000 that can employ logless component checkpointing in accordance with another aspect. The system 1000 includes one or more client(s) 1002. The client(s) 1002 can be hardware and/or software (e.g., threads, processes, computing devices).

The system 1000 also includes one or more server(s) 1004. The server(s) 1004 can also be hardware and/or software (e.g., threads, processes, computing devices). The servers 1004 can house threads to perform transformations by employing the invention, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

The one or more servers 1004 can include a middle tier component 1008 that includes an LLcom method for processing exploratory and wrap-up procedures, and supporting logging at one of the clients 1002, as described above.

Communications can be facilitated via a wired (including optical fiber) and/or wireless technology. The client(s) 1002 are operatively connected to one or more client data store(s) 1010 that can be employed to store information local to the client(s) 1002 (e.g., cookie(s) and/or associated contextual information). Similarly, the server(s) 1004 are operatively connected to one or more server data store(s) 1012 that can be employed to store information local to the servers 1004.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates exactly-once application execution, comprising:
a logless component for processing a sequence of method calls; and
a client component for controlling a recovery process of the logless component via checkpointing of state of the logless component so that recovery time is shortened should the logless component fail.

2. The system of claim 1, wherein the logless component is a middle-tier component.

3. The system of claim 1, wherein the logless component is part of a middle-tier server, the logless component includes a snapshot method for capturing values of system and application variables and other state information of the logless component during normal execution and a restore method for restoring a new logless component that is logically identical to the logless component before it failed.

4. The system of claim 1, wherein the recovery process is transparent to an application associated with the logless component.

5. The system of claim 1, wherein the logless component executes a non-idempotent read.

6. The system of claim 1, wherein the logless component is both persistent and stateful.

7. The system of claim 1, wherein the checkpointing of the state of the logless component occurs on a log associated with the client component and is used to recover the logless component when the logless component fails.

8. The system of claim 1, wherein the recovery process for a failed logless component includes replaying client calls to a new, logically identical, logless component.

9. The system of claim 1, wherein the recovery process includes reducing size of a client log needed in order to recover the logless component by checkpointing of the logless component.

10. The system of claim 1, wherein the client component invokes a snapshot method of a middle-tier server for checkpointing the state of the logless component.

11. The system of claim 1, wherein the client component invokes a restore method of the logless component that takes as an argument the state captured by a snapshot method.

12. The system of claim 11, wherein the snapshot and restore methods of the logless component are provided by inheritance from a class that includes the logless component, such that the snapshot and restore methods are not written into the logless component by the application.

13. The system of claim 1, wherein the client component is associated with a client log that captures what is perceived by a logless component as nondeterministic method calls.

14. A computer-implemented process of recovering a logless component, comprising:
receiving client functionality, including recovery functionality, associated with a multi-tier application;
performing checkpoint processing to capture state of a logless component executing as part of a multi-tier application;
storing checkpoint information as a record in a client log; and
processing the checkpoint information for recovery processing when the logless component fails.

15. The method of claim 14, further comprising an act of recreating a new logless component that is logically identical to the failed logless component.

16. The method of claim 14, further comprising an act of stepping through and replaying calls logged on the client log that are associated with the failed logless component in order to recreate the state of the logless component.

17. The method of claim 14, further comprising an act of replaying an idempotent request to a backend service as part of recovery processing.

18. The method of claim 14, further comprising an act of waiting for a message from the logless component that is expected to arrive before a predetermined timeout period.

19. The method of claim 14, further comprising an act of initiating the recovery process when a client reconnects to a middle-tier server for an application.

20. A computer-executable system, comprising:
computer-implemented means for communicating with a logless component of a middle-tier component;
computer-implemented means for invoking a snapshot method via a client component;
computer-implemented means for checkpointing application state of the logless component at an inactive time;
computer-implemented means for determining when the logless component has failed;
computer-implemented means for invoking a restore method that sets variables and other state of the logless component to values captured by the restore method; and
computer-implemented means for recreating a new logless component that is logically identical to the logless component before the logless component failed.
